(19) United States
(12) Patent Application Publication
(10) Pub. No.: US 2003/0014361 A1
(43) Pub. Date: Jan. 16, 2003

(54) Method for billing for services in a communication network

(76) Inventors: Uwe Klatt, Berlin (DE); Manfred Lilge, Berlin (DE); Thomas Ryll, Berlin (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/120,790

(22) Filed: Apr. 12, 2002

(30) Foreign Application Priority Data
Apr. 12, 2001 (EP) 01250134.2

(51) Int. Cl. G06F 17/60

(52) U.S. Cl. 705/40; 705/39

(57) ABSTRACT

The invention relates to a method for billing for chargeable services by means of a prepaid account (GK) which is kept in a communication network by an account-keeping device (KFE) for a communication terminal (KEG) registered in the communication network. To account also for services offered by an independent provider by using the prepaid account (GK),

a payment request device (ZAE) which is not under the control of an operator of the communication network sends a payment request (3) to a payment system (ZS) associated with the communication network, the payment request (3) containing an identification of the communication terminal (KEG) and a payable amount,

the payment system (ZS) determines addressing data of the account-keeping device (KFE) of the prepaid account (GK) by using the identification, and

the payment system (ZS) sends a billing message (7) to the account-keeping device (KFE) identified by the addressing data, in order to deduct the payable amount from the prepaid account (GK).

The invention relates to a method for billing for chargeable services by means of a credit account which is kept in a communication network by an account-keeping device for at least one communication terminal registered in the communication network.

It is generally known that, in communication networks, charges for communication services are deducted from credit accounts (so-called prepaid accounts) kept in these communication networks. These prepaid accounts are allocated to one or more communication terminals registered in the communication network (e.g. fixed-network telephones, mobile phones, personal digital assistants (PDAs), notebooks, computers). From such a communication terminal, communication connections can be set up and conducted for as long as there is a charge credit in the associated prepaid account. if the charge credit is used up, no new communication connections can be established and existing communication connections are interrupted.

In this known method, the prepaid accounts are kept in the communication network in which the communication connections are also established, that is to say the services are rendered. The operator of such a communication network has access to the prepaid accounts kept in this communication network and can deduct credit amounts from the prepaid accounts in accordance with the services rendered in the communication network. The operator of such a communication network is thus responsible both for rendering the services and for billing for the costs arising from the services.

In modern communication networks, mechanisms are known in which providers independent of the communication network can render services for the communication terminals connected to the communication network; in this arrangement, the communication network is “opened”, so to speak, for the independent providers. In this context, independent providers are understood to be those who are not operators of the communication network. Such mechanisms are known by the designation open service architecture (OSA) or “parlay”. Such independent providers are also called “third party service providers”. Services of such independent providers have previously been billed via accounts in which the user of the service pays for the costs accrued after the service has been rendered (so-called “postpaid accounts”).

The invention is based on the object of specifying a method by means of which services offered by an independent provider can also be billed for by using a prepaid account of the communication network.

In a method of the type specified above, this object is achieved in accordance with the invention in that a payment request device which is not under the control of an operator of the communication network sends a payment request to a payment system associated with a communication network, the payment request containing an identification of the communication terminal and a payable amount, the payment system, by using the identification, determines addressing data of the account-keeping device of the prepaid account and the payment system sends a billing message to the account-keeping device identified by the addressing data in order to deduct the payable amount from the prepaid account. It is particularly advantageous in this connection that the independent payment request device (i.e. the one not under the control of an operator of the communication network) can bring about a billing for the chargeable services by sending the payment request to the payment system without the independent payment request device having to have direct access to the prepaid account. The independent payment request device does not even have to have information on the internal organization of the credit accounts in the communication network.

The method according to the invention can be designed in such a way that the payment request contains data from which the identity of the payment request device is determined. In this connection, it is particularly advantageous that, due to the knowledge of the identity of the payment request device, for example all transactions occurring in conjunction with the payment request device involved can be logged.

The method can be designed in such a manner that the authorization of the payment request device for participation in the method is checked by using the identity determined. This ensures that only those payment request devices which have a corresponding authorization participate in the method. For example, it is conceivable that such authorizations are only issued to those payment request devices of independent service providers which have been checked and graded as reliable by the operator of the communication network.

The method according to the invention can also be designed in such a manner that the payment system orders an address-finding device to determine the addressing data of the account-keeping device of the prepaid account. In this type of embodiment, it is particularly advantageous that the payment request device only needs to know the identification of the relevant communication terminal (that is to say, for example, the MSISDN of this device). The payment request device does not, however, need to have any information on what type of account is allocated to the respective communication terminal and which account-keeping device keeps this account, since this information is supplied by the address-finding device.

The method according to the invention can also be designed in such a manner that the addressing data are interrogated from a data storage node of the communication network. In this context, it is particularly advantageous that data storage nodes are often present in known communication networks (e.g. GSM networks) (e.g. in the form of HLR (home location register) nodes). According to the invention, the addressing data can also be stored in such data storage nodes so that no additional data storage nodes are necessary for implementing the method.

The method according to the invention can be designed in such a manner that, together with the billing message, the identification and/or the payable amount are sent to the account-keeping device. It is then advantageous that all the data needed by the account-keeping device in the further sequence of the procedure are transmitted to the account-keeping device with only one message.

The method according to the invention can also be designed in such a manner that the payment system keeps at least one suspense account associated with the payment request device and, after the payable amount has been deducted from the prepaid account, this payable amount is credited to the suspense account. It is particularly advantageous in this connection that, after the payable amount has been deducted from the prepaid account, this payable amount is first credited to the suspense account of the payment system and thus the payable amounts can already be processed further in the payment system.

The method according to the invention can be designed in such a manner that the credited payable amounts of a number of successive payment requests are added together in the suspense account and the sum of payable amounts calculated in each case is transferred at billing time intervals to a money account associated with the payment request device, the billing time intervals being greater than the average time interval between in each case two successive payment requests. This transfer of the sum of payable amounts can be, e.g., a remittance, a debit item or another familiar money transaction procedure. It is particularly advantageous in this connection that, due to the summation of the payable amounts and the relatively long billing time intervals, only relatively few transfers of the aggregate payable amounts to the money account of the payment request device are necessary. Due to the summation, sums of payable amounts are transferred which are greater than the individual payable amounts. Since each transfer to a money account is, on the one hand, complex and, on the other hand, often associated with additional transfer charges (e.g. remittance fees), a simple and inexpensive billing method can be implemented in this manner.

The method according to the invention can be designed in such a manner that the payment request device monitors the rendering of the chargeable services and the payment request device prevents the payment request from being sent to the payment system if the rendering of a service is unsuccessful. It is advantageous in this connection that, e.g. when a fault occurs which has the consequence that the service is not correctly rendered, no payment request is sent to the payment system and thus no payable amount is deducted from the prepaid account, either.

The method according to the invention can also be designed in such a manner that successively a number of part-payment requests, in each case containing a part payable amount, are sent to the payment system, the magnitude of the part payable amounts in each case corresponding to a part-service rendered. This design of the method is advantageous, in particular, when an extensive service to be rendered can be divided into a number of part-services. Each time a part-service has been rendered, a corresponding part-payment request can be sent to the payment system, as a result of which a billing of the part payable amounts associated closely in time with the rendering of the part-service is possible both for the service provider and for the receiver of the service.

For the further explanation of the invention,

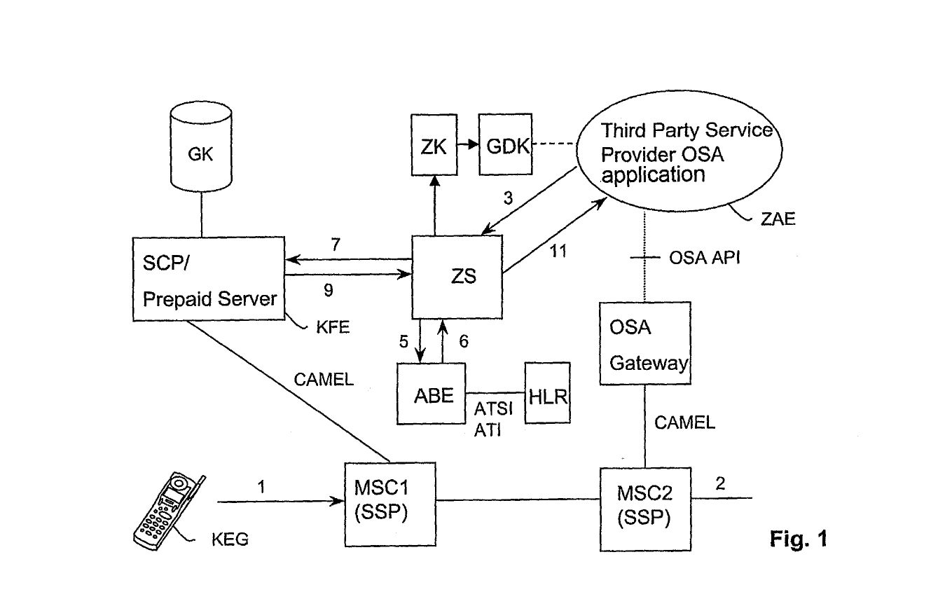

FIG. 1 shows an exemplary embodiment of an OSA application and of a section from a communication network for applying the billing method, and

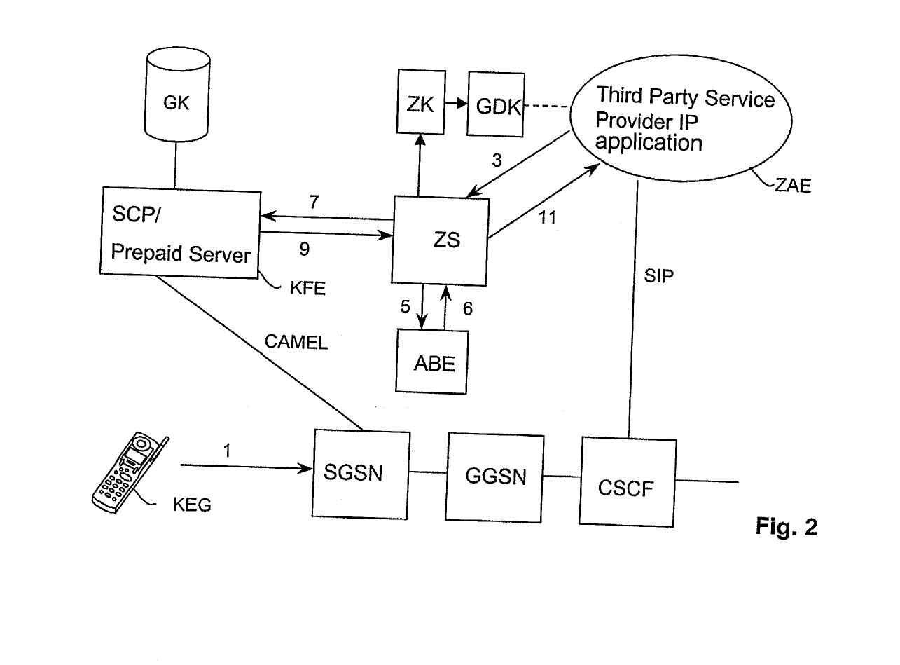

FIG. 2 shows an exemplary embodiment of an IP application and of a section of a communication network for applying the billing method.

FIG. 1 diagrammatically shows exemplary embodiments of method steps by means of which chargeable services in the form of voice services can be preferably billed. In the present context, voice services are understood to be services in which information is transmitted to the service user by aural means (that is to say, e.g. by means of natural or synthetically generated speech). A communication terminal KEG (e.g. a mobile phone or a fixed-network telephone) is connected to a communication network via a network link 1. This network can be, for example, a telecommunication network (mobile radio network) according to the widely used GSM (global system for mobile communication) standard. The communication network includes a first mobile switching center MSC1 and a second mobile switching center MSC2. The first mobile switching center MSC1 is connected to an account-keeping device KFE. Such an account-keeping device can be, for example, a service control point SCP if the communication network has the structure of an intelligent network (IN). In this intelligent network, the first mobile switching center MSC1 and the second mobile switching center MSC2 have the function of a service switching point SSP.

Such an account-keeping device is frequently also called a prepaid server if prepaid credit accounts are kept by this device. The communication link between the first mobile switching center MSC1 and the account-keeping device KFE is implemented by using the CAMEL (Customized Applications for Mobile Network Enhanced Logic) standard. The account-keeping device KFE is connected to a payment system ZS which, in turn, has a connection to an address-finding device ABE. The payment system ZS and the address-finding device ABE can be components of the communication network, but they can also be formed by independent units which are connected externally to the communication network.

The second mobile switching center MSC2 of the communication network is connected to an OSA gateway. This OSA gateway establishes a connection to a payment request device ZAE via an OSA API (OSA application programming interface). Such a payment request device ZAE can be implemented by an OSA application which is capable of communicating with the OSA gateway via the OSA API interface. In the present exemplary embodiment, a third party service provider OSA application is used which is associated with the third party service provider. The payment request device ZAE does not belong to the communication network; instead, the payment request device is operated independently of the communication network, neither is it subject to the control of an operator of the communication network.

The procedural sequence described in the text which follows is based on the situation that, for example, a voice service is to be rendered for the communication terminal KEG. Such a voice service can consist e.g. in that current information such as e.g. exchange rates or the latest news are automatically announced to the communication terminal KEG. For this purpose, for example, a voice announcement device can be connected to a terminal 2 of the second mobile switching center MSC2; the voice information is then transmitted via a communication link to the communication terminal KEG, the communication link being established via the two mobile switching centers MSC1 and MSC2. Since this voice service is a chargeable service, the payment request device ZAE has to debit this chargeable service to the communication terminal KEG.

The rendering of the voice service can be initiated either by the payment request device ZAE or can also be initiated by a further device (not shown in the figure). In the latter case, the further device only orders the payment request device ZAE to debit the chargeable service.

The communication terminal KEG is associated with a prepaid account GK in the communication network, which is kept by the account-keeping device KFE. The costs relating to the communication terminal KEG are debited via this prepaid account GK. The prepaid account GK can be kept, e.g. in a database connected to the account-keeping device KFE or in the account-keeping device itself. However, the payment request device ZAE is barred from directly accessing the prepaid account GK since the prepaid account GK is kept internally in the communication network but the payment request device ZAE is operated independently of the communication network and is not subject to control of a communication network operator.

As a prerequisite for participating in the billing method, the payment request device ZAE was made known to (registered with) the operator of the communication network in advance of the procedure. For this purpose, information for determining the identity of the payment request device was stored in the communication network or in the payment system ZAE. Such information can be, e.g. so-called signatures by means of which the messages sent by the payment request device ZAE to the payment system ZS are signed. Furthermore, for example, the name, the address and the bank details of the operator of the payment request device can be stored. It can also be stored that the payment request device is authorized to send payment requests to the payment system for those customers for whom a prepaid account GK is kept in the communication network.

At the beginning of the service billing procedure, the payment request device ZAE sends a payment request 3 to the payment system ZS. Such a payment request contains an identification of the communication terminal KEG. Such an identification can be e.g. the MSISDN of the communication terminal KEG, that is to say an E.164 number. Furthermore, the payment request 3 contains the payable amount for the service to be billed. Similarly, the payment request 3 can contain a designation of the chargeable service (product ID). The payment request 3 can also contain data from which the payment request device ZAE is recognizable (service provider ID). This is because the payment request device is called a third party service provider if it is also responsible for rendering the services, in addition to billing for the service.

The payment system ZS then determines the identity of the payment request device ZAE (of the third party service provider) by means of the payment request 3. On the one hand, the service provider ID transmitted in the payment request can be used for this purpose, or a signature of the payment request device by means of which the payment request was signed can be evaluated (the signing of messages is generally known by the keyword “public key infrastructure”).

The payment system ZS now knows the communication terminal KEG since its identification has been transmitted in the payment request. The payment system ZS must now determine which account-keeping device of the communication network keeps the charge account of the communication terminal KEG. This is because a communication network can contain a number of account-keeping devices which in each case keep selected prepaid accounts. The payment system ZS, therefore, sends an interrogation message 5 to the address-finding device ABE. This interrogation message 5 contains the identification of the communication terminal KEG. Using the identification, the address-finding device ABE determines which account-keeping device is keeping the account of the communication terminal KEG and sends addressing data of this account-keeping device, together with a response message 6, back to the payment system ZS. The association between the identification and the addressing data of the account-keeping device can either be stored in the address-finding device ABE itself (for example in a data memory) or the address-finding device (ABE) can access a data storage node of the communication network, in which this association is stored. Such a data storage node can be, for example, the home location register HLR existing in many communication networks, in which data of the communication terminal KEG are stored.

Apart from the data originally stored in the HLR, the needed association of the identification (e.g. MSISDN) of the communication terminal KEG with the account-keeping device can also be advantageously stored in the home location register HLR in this procedure. Thus, the HLR hardware already existing in the communication network can be used for a new application.

Such an interrogation of HLR data can be performed, for example, with the aid of the familiar CAMEL operation ATSI (any time subscription interrogation) or the CAMEL operation ATI (any time interrogation).

The home location register HLR or also the address-finding unit ABE thus translates the E.164 address of the communication terminal into the SS7 (signaling system No. 7) address of the account-keeping SCP (i.e. the account-keeping device). In addition, the payment system ZS can be informed by the address-finding device ABE about whether the communication terminal KEG is associated with a prepaid account at all or whether the communication terminal KEG is associated with a postpaid account.

Once the payment system ZS has received the addressing data from the address-finding device ABE, it sends a billing message 7 to the account-keeping device KFE identified by the addressing data, i.e. to the account-keeping device which administers the account of the communication terminal KEG. This billing message 7 can contain, for example, the payable amount and the identification of the communication terminal KEG. After receiving the billing message 7, the account-keeping device KFE selects the prepaid account GK associated with the communication terminal on the basis of the identification of the communication terminal KEG, deducts the payable amount from the prepaid account GK and sends a billing confirmation message 9 back to the payment system ZS.

The payment system ZS keeps a suspense account ZK associated with the payment request device ZAE. This is an account in which the payable amounts deducted from the prepaid account are temporarily kept. The suspense account ZK is thus credited with an amount corresponding to the payable amount and, following this, a confirmation message 11 is sent from the payment system ZS to the payment request device ZAE. This confirmation message 11 informs the payment request device that the payable amount has been successfully deducted.

The amount temporarily credited to the suspense account of the payment system can be added at a later time, for example to the temporarily credited amounts of other payment requests (combined) and at certain billing time intervals (for example at the end of a day in each case), a money amount corresponding to the sum of the payable amounts can be credited to a conventional money account GDK of the payment request device (for example in a bank). After this money crediting, the sum of the payable amounts in the suspense account is cleared. The payment system logs all running transactions and stores the data for a later check.

A significant advantage of the method hitherto described consists in that the billing of chargeable services can be done in real time, i.e. that after the payment request 3 has been sent from the payment request device ZAE to the payment system ZS, the further procedural steps occur immediately and the confirmation message 11 is sent back to the payment request device ZAE only a short time thereafter. As a result, the method described can proceed, for example, before a communication link is set up to the communication terminal KEG (which is used for rendering the chargeable service) without a user of the communication terminal KEG having to accept any significant delay due to the billing method. Similarly, the billing method can also be carried out during the communication connection or at the end of the communication connection, however.

FIG. 2 shows another example of an application of the method described for billing chargeable services. FIG. 2 shows a section of a UMTS telecommunication network (third-generation mobile radio network) which is connected to a payment request device ZAE in the form of an IP (Internet protocol) application.

In distinction from FIG. 1 in which the first mobile switching center MSC1, and the second mobile switching center MSC2 and the account-keeping device KFE are shown as parts of the communication network which are essential to the example, FIG. 2 shows as essential components of the UMTS communication network a switching center SGSN (serving GPRS (general packet radio service) support node), a node GGSN (gateway GPRS support node) and the account-keeping device KFE. UMTS networks are particularly suitable for transmitting data and for rendering data services.

The IP application operates not only as payment request device ZAE analogously to the manner shown in FIG. 1 but also directly renders the chargeable service (in this case, e.g., an IP data service such as voice over IP (VoIP)). For this purpose, the IP application is connected to the UMTS communication network via a node called call state control function (CSCF); communication between the IP application and the CSCF node takes place by means of a communication protocol called session initiation protocol (SIP).

Thus, the third party service provider IP application renders the chargeable service directly for the communication terminal KEG; for example, VoIP data can be transmitted from the IP application via the CSCF, GGSN and SGSN elements to the communication terminal KEG. To account for the costs for this chargeable service, the IP application sends a payment request 3 in familiar manner to the payment system ZS. The further sequence corresponds to the sequence shown in FIG. 1.

It should be expressly pointed out that the payment system ZS and the address-finding device ABE as shown in the figures can be implemented as two separate units between which a data exchange takes place. Naturally, however, it is also possible that the payment system ZS and the address-finding device ABE are implemented jointly in one network element. Similarly, the first mobile switching center MSC1 and the second mobile switching center MSC2 can also be implemented as a single switching center. The payment request device ZAE can either be used only for requesting a payment by using the prepaid account or can also perform other actions, for example it can additionally render the service forming the basis for the payment (e.g. render a service).

Using the method described, chargeable services can be billed in real time to prepaid accounts in communication networks. This is also possible when a service provider independent of the communication network (third party service provider) renders these chargeable services or accounts for them. By using the payment system ZS with the address-finding device ABE and the corresponding interfaces, the payment request device ZAE of the independent service provider can bill for chargeable services without itself directly accessing the prepaid account or having information on internal implementations of the prepaid account or of the mechanisms for accessing the prepaid account. As a result, the security interests of the communication network operator are taken into consideration, since he does not have to convey any information on his internal account-keeping and book-keeping methods to the payment request device ZAE.

What is claimed is:

1. A method for billing for chargeable services by means of a prepaid account (GK) which is kept by an account-keeping device (KFE) in a communication network for at least one communication terminal (KEG) registered in the communication network, in which
a payment request device (ZAE) which is not under the control of an operator of the communication network sends a payment request (3) to a payment system (ZS) associated with the communication network, the payment request (3) containing an identification of the communication terminal (KEG) and a payable amount,
the payment system (ZS) determines addressing data of the account-keeping device (KFE) of the prepaid account (GK) by using the identification, and
the payment system (ZS) sends a billing message (7) to the account-keeping device (KFE) identified by the addressing data, in order to deduct the payable amount from the prepaid account (GK).

2. The method as claimed in claim 1, characterized in that
the payment request (3) contains data from which the identity of the payment request device (ZAE) is determined.

3. The method as claimed in claim 2, characterized in that
the authorization of the payment request device (ZAE) for participation in the method is checked by using the identity determined.

4. The method as claimed in claim 1, characterized in that
the payment system (ZS) orders an address-finding device (ABE) to determine the addressing data of the account-keeping device (KFE) of the prepaid account (GK).

5. The method as claimed in claim 4, characterized in that
the addressing data are interrogated from a data storage node (HLR) of the communication network.

6. The method as claimed in claim 1, characterized in that
together with the billing message (7), the identification and/or the payable amount are sent to the account-keeping device (KFE).

7. The method as claimed in claim 1, characterized in that
the payment system (ZS) keeps at least one suspense account (ZK) associated with the payment request device (ZAE), and
after the payable amount has been deducted from the prepaid account (GK), this payable amount is credited to the suspense account (ZK).

8. The method as claimed in claim 7, characterized in that
in the suspense account (ZK), the credited payable amounts of a number of successive payment requests (3) are added together, and
the sum of payable amounts calculated in each case is transferred at billing time intervals to a money account (GDK) associated with the payment request device (ZAE), the billing time intervals being greater than the average time interval between in each case two successive payment requests (3).

9. The method as claimed in claim 1, characterized in that
the payment request device (ZAE) monitors the rendering of the chargeable services and
the payment request device (ZAE) prevents the payment request (3) from being sent to the payment system (ZS) if the rendering of a service is unsuccessful.

10. The method as claimed in claim 1, characterized in that
successively a number of part-payment requests, in each case containing a part payable amount, are sent to the payment system (ZS), the magnitude of the part payable amounts in each case corresponding to a part-service rendered.
